(19) United States
(12) Patent Application Publication
(10) Pub. No.: US 2005/0071869 A1
(43) Pub. Date: Mar. 31, 2005

(54) Informational material selection

(76) Inventor: Jon Arthur Fairhurst, Camas, WA (US)

Correspondence Address: Kevin L. Russell, Suite 1600, 601 SW Second Ave., Portland, OR, 97204-3157, US

(21) Appl. No.: 10/676,986

(22) Filed: Sep. 30, 2003

(51) Int. Cl. G06F 3/00; H04N 5/445; G06F 13/00

(52) U.S. Cl. 725/46

(57) ABSTRACT

The selection of informational material.

### BACKGROUND OF THE INVENTION

The present invention relates to the selection of informational material.

Television broadcasting technology has improved tremendously since its inception. Television signals are broadcasted on the airwaves, broadcast through cable, fibre, and networked connections, and broadcast via satellites. The number of available stations readily accessible today has increased from one to hundreds, if not thousands, of stations. To select a program to view, many viewers simply use the remote control to “channel surf” until they find a channel that has a desirable program. Channel surfing refers to the process of using the channel “+” or “−” key on the remote control to sequentially view each channel on the display. Although some viewers find channel surfing among hundreds of stations enjoyable, most viewers prefer a more direct method for selecting a program to view.

Some systems, for example, the RCA Direct Satellite System or DSS (Direct Satellite System and DSS are trademarks of Hughes Communications, a division of General Motors Corp.), provide a television channel selection guide which displays a listing of the channels typically in numeric order and the titles of the programs broadcasted or to be broadcasted on the channels. A simplified block diagram of such a guide is illustrated in FIG. 1. The viewer or user of the system may then select the channel by entering in the number or selecting the device. The system responds by removing the guide displayed and tuning to the station selected and displaying the broadcasting signals of the station.

This system has a number of drawbacks. The guide provides only the title of the program. To get additional information, such as a written description of the program, the user must select an information button which responds by bringing up a second layer of the menu having the program description. Thus, as the number of stations increase, the efficiency of reviewing programs and program descriptions decreases.

Typical television viewers will have favorite stations which they like to watch. Some systems provide a channel skip function in which a viewer or user of the system can designate those channels that they prefer to view by selecting those channels from a displayed list of channels. Thereafter, using the channel “+” or “−” buttons, the user can sequentially view those selected channels.

In many cases the user desires to view informational material on their television, such as for example, financial information, weather information, news information, sporting information. Typically such informational material is available to the television through one of the broadcast channels, through data services provided together with digital signals, Internet based connections, cable television connections, satellite connections, networked based connections, wireless connections, etc. In many cases, the user of the television may navigate through many menu choices using the remote control, requiring the pressing of several different buttons on the remote control in order to view the desired content. While such menu navigation is perhaps appropriate to those who are familiar with the complex navigation of menus and buttons on the remote control required to view the desirable content, it is problematic for the casual user who simply desires to view desirable content.

Other types of devices such as a personal computer and WebTV permit browsing of the Internet on a typical television or monitor, both of which permit the user to view such informational material. Similarly, the user of such devices is required to navigate through many menu choices using the remote control or keyboard, requiring the pressing of several different buttons on the remote control or keyboard. While perhaps appropriate to those who are familiar with the complex navigation of menus and buttons on the remote control or keyboard required to view the desirable content, it is problematic for the casual user who simply desires to view desirable content.

Some types of navigational assistance has been attempted with respect to favorite programming. Chilamakuri et al., U.S. Pat. No. 6,285,414, disclose a channel selector for a television receiver for deselecting specified channels for a predetermined period of time. When a channel has been deselected it will be skipped when a user “surfs” through the sequence of channels. After the predetermined period of time expires the deselected channel is returned to the sequence of available channels. Channels may be deselected for time periods corresponding to a standard time slot, for example each half hour. Alternatively, channels may be deselected for periods corresponding to the actual length of the program determined from transmitted program scheduling data. While of some benefit to reduce the number of channels while the user channel surfs, the de-selection only lasts for a limited duration. Moreover, it is burdensome to manually de-select many channels from a selection of hundreds.

Atkinson, U.S. Pat. No. 6,084,644, discloses a television remote control with channel-defined keys. The remote control includes a plurality of control keys having a pair of volume keys for remotely controlling a volume of the television, and a pair of channel toggle keys for remotely changing channels of the television in an incrementing and decrementing manner. The remote control also includes a plurality of user keys configured in a matrix. Each user key effects the transmission of a signal to change the channel of the television to a predetermined channel associated with the user key. Each user key has indicia associated therewith which corresponds with the corresponding channel. While efficient after the user has gone through the arduous task of programming all the keys, it is quite burdensome to reprogram the keys each time the user's preferences change.

Blondstein, et al., U.S. Pat. No. 5,978,043 disclose a television (TV) graphical user interface (GUI) in a satellite TV system to enable users to create customized channel lists. Everyday, favorite and theme lists may be generated to respectively combine TV channels being watched regularly, favorite TV channels and channels relating to particular subjects. In a regular channel changer mode, the TV GUI displays graphical channel changer composed of channel boxes that show numbers and logos of available TV channels. To create a customized channel list, the TV GUI is switched into a change list content mode, wherein a channel grid is displayed in addition to the channel changer. Using a “drag and drop” procedure, graphical boxes corresponding to selected channel boxes may be moved from the channel changer to cells of the channel grid, to create a customized list of TV channels or to add new channels to an existing list. TV channels may be removed from the list by moving boxes that represent unwanted channels from the grid and placing them outside the grid area. TV channels may be put into the customized list in order of their priority established by the user. The position, graphical configuration and operations of the channel changer that represent the customized channel list remain unchanged compared with the channel changer in the regular channel changer mode. Accordingly, the user manually creates a favorites list which the user accesses through a set of actions.

Noguchi, et al., U.S. Pat. No. 6,426,779, disclose a line guide that provides the user of a multiple channel television broadcast system with programming information. The guide enables the user to select a particular program to watch. In particular, the system enables the user to scan program information of channels that the user has designated as his favorite channels. A button is provided that is designated as “favorite”. When the user is in a broadcast guide and selects the button, the system responds by displaying program information regarding the favorite stations at the top of the guide. Thus, the user sees at the top of the list the current programming with respect to his favorite stations, followed by program information for the remaining stations. Accordingly, the user manually creates a favorites list, and in response to pressing the button designated as “favorite” while browsing an electronic program guide, presents the list of favorites.

Sony, in a WEGA TV KV-32FS13, incorporates a favorite channel button on the remote control. The favorite channel functionality may alternatively be, access to any one of 5 programmed channels, or access to the last 5 channels that the user just watched or switched through.

### BRIEF DESCRIPTION OF THE DRAWINGS

FIG. 1 illustrates an electronic programming guide.

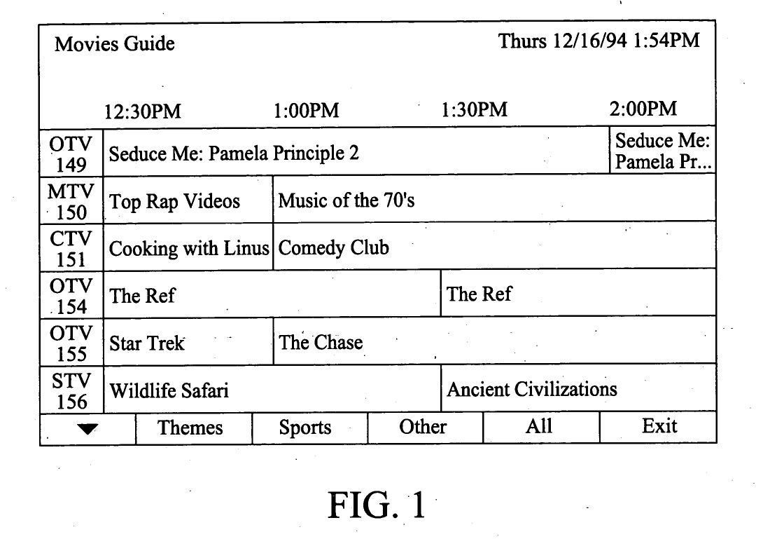

FIG. 2 illustrates a television system.

FIG. 3 illustrates a remote control.

FIG. 4 illustrates functionality of the remote control.

FIG. 5 illustrates determination of the favorite channels.

FIG. 6 illustrates the presentation of favorite channels.

### DETAILED DESCRIPTION OF THE PREFERRED EMBODIMENTS

In the system described herein the system may be a WebTV or personal computer that has the capability of receiving and displaying different types of informational material at different times on the display. In addition, the system may be a broadcast satellite system or any system which has the capability of receiving and displaying a multiplicity of different stations and/or a plurality of different types of informational material at different times on the display. Furthermore, in the following description, for purposes of explanation, numerous details are set forth, such as menus, flowcharts and system configurations, in order to provide a thorough understanding. However, it will be apparent to one skilled in the art that these specific details are not required. In other instances, well known electrical structures and circuits are shown in block diagram form.

The present inventor considered the existing techniques for viewing the informational material on their web browsing device or television, and determined that they are either to cumbersome for a user to effectively use in a hurried and busy lifestyle, or otherwise to simplistic to provide useful information. Moreover, the present inventor has come to the realization that the user's more desirable informational material tends to change over time. In addition, the desirable informational material may tend to change depending on the particular time of the day and/or the day of the week. Further, the present inventor has come to the realization that the user's viewing habits are temporal in nature and accordingly the user's actual preferences may be related, in some manner, to the duration that a particular informational material is watched.

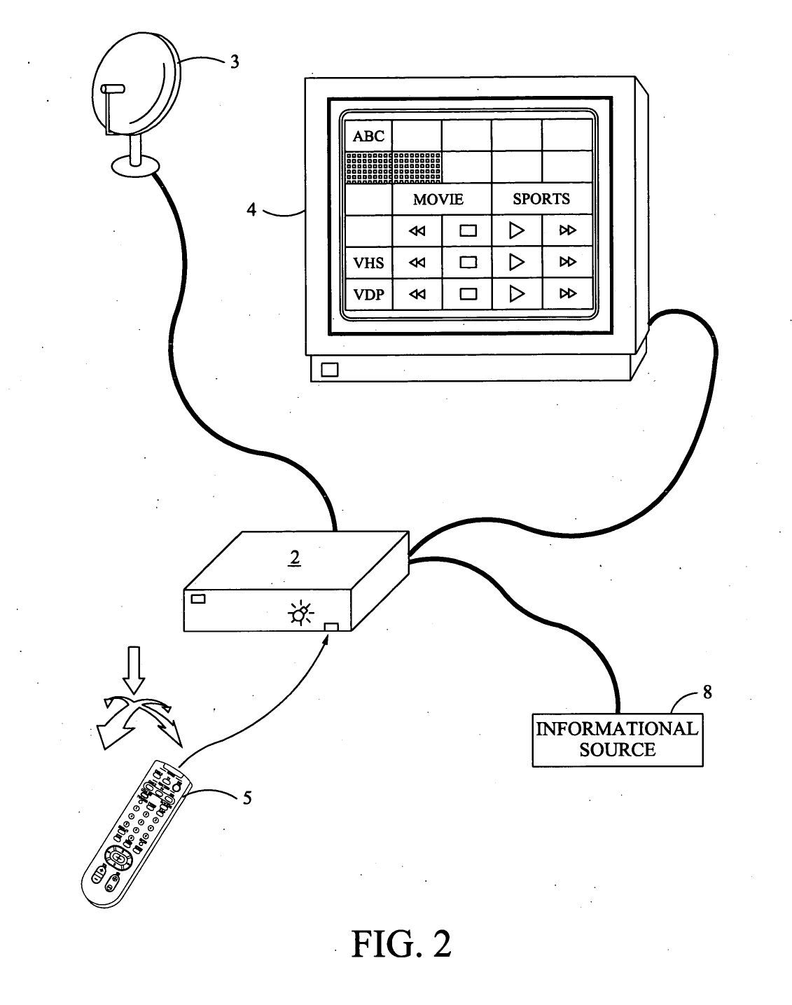

FIG. 2 is a simplified diagram illustrating a satellite system. The system includes an antenna 3, an integrated receiver/decoder 2 (IRD), a remote controller 5 and a monitor 4. The video, normally in the form of packets, is transmitted by a transponder on the satellite. Each transponder normally transmits data in a time share manner at a predetermined frequency. A tuner of a decoder is tuned in to the frequency of the transponder corresponding to a channel, which is designated by a viewer so that the packets of digital data are received by the decoder.

The antenna 3 receives the video signal sent from a satellite. The video signal is provided to the IRD. The antenna 3 may include a block down converter (LNB). The LNB converts the frequency of the signal sent from the satellite to a lower frequency. The converted signal is supplied to the IRD. The monitor 4 receives a signal from the IRD. The IRD may likewise receive informational material from an information source 8 which is provided to the monitor 4 for presentation.

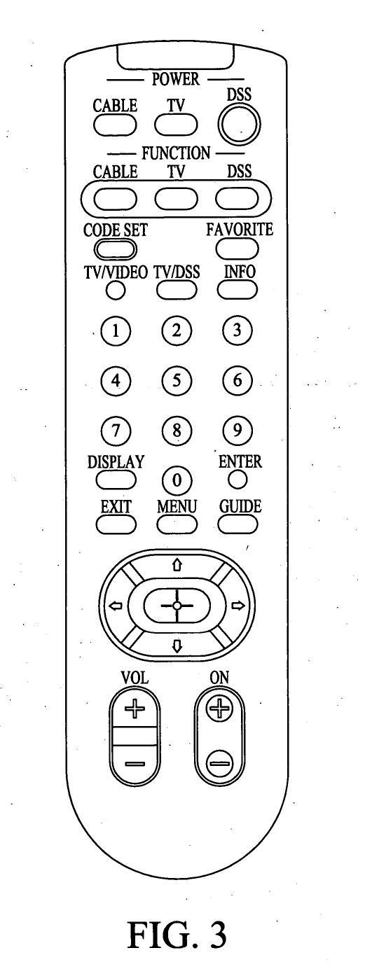

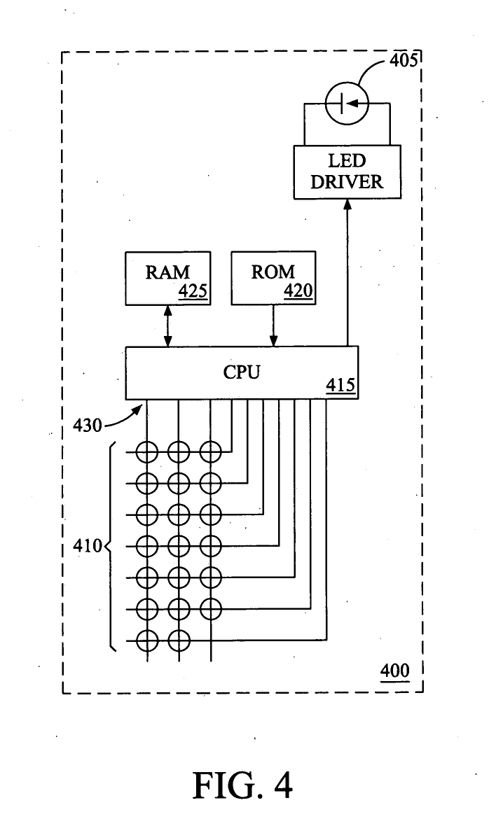

FIG. 3 shows an example of a remote controller utilized by a user to transmit commands and make program selections in accordance with the teachings of the present invention. FIG. 4 is simplified a block diagram of the remote controller. The remote controller 400 has an infrared originating device 405, a set of operation buttons 410, a CPU 415, a ROM 420 and a RAM 425. The CPU 415 receives a signal sent from an operation button 410 through an input port 430. The signal is processed according to a program stored in the ROM 420. The RAM 425 is used as a working space so as to produce a transmitting code. The transmitting code is sent to the infrared originating device 405 through an output port and converted into an infrared signal. The infrared signal is transmitted to the IRD. The operation buttons 410 include a direction key for designating a pointer direction such as north, south, east and west, an “EPG” key, a “FAVORITE” key, a “SELECT KEY”, a “MENU” key, an “EXIT” key, a ten-key numeric keypad, an “INFORMATION” key, and an “ENTER” key. The set of operation buttons 410 enable the user to select programs through the electronic programming guide in accordance with the teachings of the present invention.

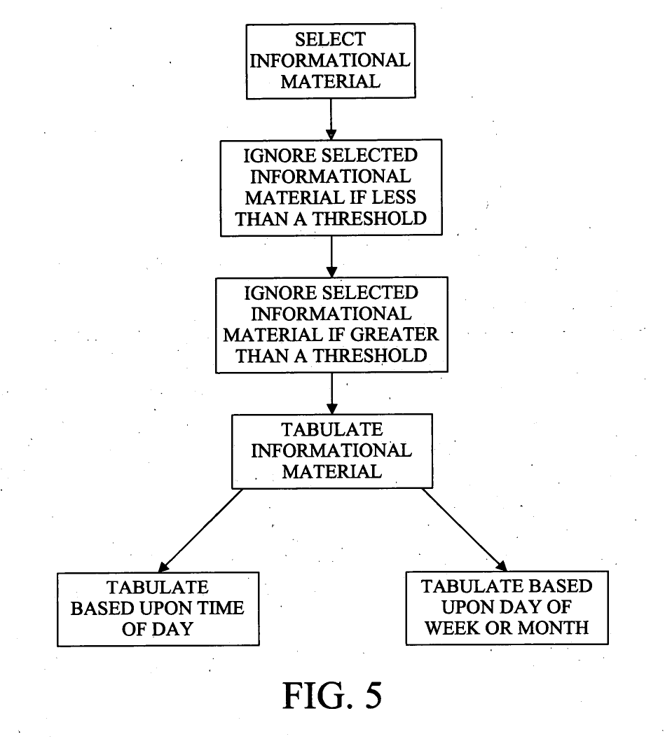

Referring to FIG. 5, while the user views particular informational material or otherwise changes the channel to informational material, the system identifies the particular informational material as one of potential interest to the user. In many cases informational material is presented in a sequential manner, such as on a screen by screen basis. For example, the viewer may desire to primarily view the sports information which may require scrolling through several other informational screens first. Accordingly, the present inventor came to the realization that in the case that the selected informational material is viewed for a duration shorter than a threshold value, such as 3 seconds, the particular informational material is not likely highly desirable informational material for that particular user. Accordingly, the informational material viewed for an insufficient duration may be ignored or otherwise provided a reduced weighting toward the desirable informational material. The number of times and/or duration that different informational material is observed, in excess of the threshold, may be tabulated. This tabulation may be limited for a particular time period, such as 7 days, so that as the user's preferences change the tabulation will be automatically updated accordingly. For example, after several days of watching sports information the previous watching of news information will be of lesser value in the tabulation. Based upon the temporal viewing habits of particular informational material the system may determine a set of likely preferences for the user. The preferences may be limited to a predetermined number of informational materials or otherwise less than all available informational materials, if desired.

After further consideration the present inventor came to the realization that most active viewers of informational material tend to view such materials for a limited period of time before changing to different information or otherwise switching to television programming. Accordingly, the present inventor came to the realization that in the case that the selected informational material is viewed for a duration greater than a threshold value, such as 45 seconds, the particular informational material is not likely highly desirable informational material for that particular user, as the viewer was likely distracted. Accordingly, the informational material viewed for an excessive duration may be ignored or otherwise provided a reduced weighting toward the desirable informational material. The number of times and/or duration that different informational material is observed, less than the threshold, may be tabulated. This tabulation may be limited for a particular time period, such as 7 days, so that as the user's preferences change the tabulation will be automatically updated accordingly. For example, after several days of watching sports information the previous watching of news information will be of lesser value in the tabulation. Based upon the temporal viewing habits of particular informational material the system may determine a set of likely preferences for the user. The preferences may be limited to a predetermined number of informational materials or otherwise less than all available informational materials, if desired. The system may employ the low threshold, the high threshold, or both, as desired.

After further consideration it turns out that users tend to view different informational materials at different times of the day. For example, some users may tend to view news in the morning, financial information in the afternoon, and news late in the evening. Referring to FIG. 5, the selected informational materials may likewise depend on the particular time of the day that the informational materials are observed. For example, the time of the day may be defined as morning, afternoon, evening; by hour (e.g., truncating the minutes); hour range; minute range; etc. This permits more accurate selection of the informational materials by the system.

After further consideration it turns out that users tend to view different informational material on different days of the week or month. For example, some users may tend to watch financial information on Wednesday, and sporting information on Saturday. Referring to FIG. 5, the selected informational material may likewise depend on the particular day of the week or month that the informational materials are observed. For example, the day of the week may be defined as Monday, Tuesday, Wednesday, Thursday, Friday, Saturday, and Sunday. This permits more accurate selection of the informational material by the system. The day of the week/month together with the time of the day modifications are preferably used in combination with one another.

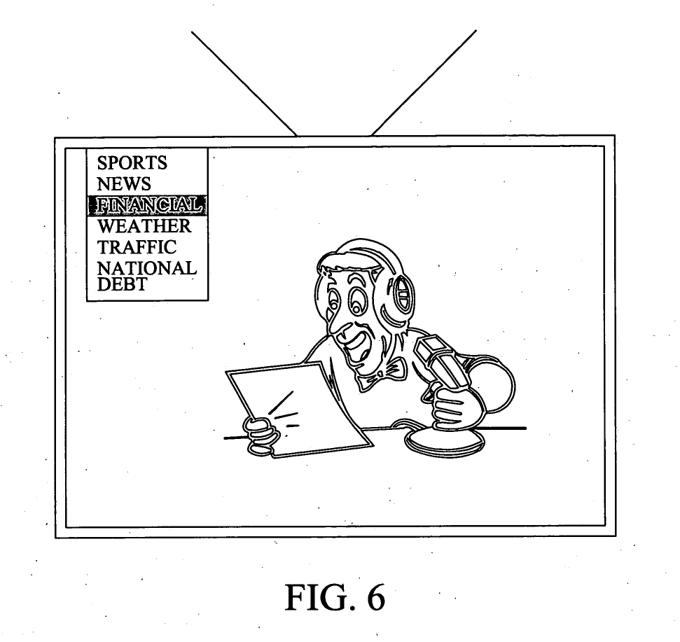

Any suitable mechanism may be used to select the likely desirable informational materials based upon one or more of the previous characteristics. For example, the longer the content is observed the greater its weight, the more times the content is observed the greater its weight, etc. In addition, the potential desirable informational materials may be ranked in some manner based upon the selection criterion used. Referring to FIG. 6, with the selected channels ranked according to a user's preference, the highest ranked informational material is preferably presented to the user first as an option, and so forth, through the set of informational material. The presentation of the “first” informational materials take many forms, such as for example, (1) showing a set of informational materials with the highest ranking one first in the list, (2) changing through the informational materials one-by-one with the highest ranking one presented first, or (3) otherwise having a presentation mechanism for the highest ranking informational material being the default for selection.

As it may be observed the favorites (or a portion thereof) are automatically selected by the system in a manner free from explicit user definition. In this manner the user does not have to laboriously program his desired informational material into the system. In addition, it may be observed the informational material (or a portion thereof) are automatically updated or otherwise modified by the system in a manner free from explicit user selection. This dynamic generation of the initial informational material and the dynamic updating of the informational material is straightforward for the user and in essence permits the building of a list of informational material.

For the preferred remote control, there is a single “information” button (INFO) that activates the informational material selection. In this manner, the user is free from being required to associate different informational materials with different buttons on the remote control or otherwise navigate through a series of menus. The remote control, television, and/or other device in communication with the remote control may identify the informational materials, determine those that are likely desirable, and store the results. The information materials may be exited in any manner, such as for example, scrolling through all of them or pressing an EXIT button. In addition, the system may be programmed or otherwise information provided to the system by the user indicating their preferences, such as for example, their location, their stock interests, particular types of news of interest, etc.

The system may further include identification of the user in some manner. In this manner, separate favorites may be determined and maintained. In this manner, a 4 year old child will likely have a different set of informational materials than a 17 year old child. Also, the information button may likewise be “virtual” in nature as being soft buttons displayed on a display device such as the television or remote control.

It is to be understood that any video presentation device may be used, such as for example, a personal computer, handheld display device, cellular phone, etc. In addition, any of the video presentation devices may likewise include a remote control, although the functionality may be performed without a remote control, if desired.

In many cases, the functionality provided by the system may be incorporated in a set top box, a digital television, or other device. In the event that there is sufficient memory, all of the functionality may be provided in a single monolithic application. In many cases, there is insufficient memory available to store an application that incorporates all of the potential functionality. In such a case, the functionality may be made available to the device in a modular fashion, based upon the user's desires or functionality selected. This helps to optimize the memory usage of the system.

In some cases the system may have a limited amount of available storage for the information that the user may desire to store. In such a case, the system may have a hierarchical priority for which information to cache. In cases where the available cache is full or sufficiently full, items with a lower priority may be removed from the cache and replaced with items having a higher priority. In addition, the system may develop a model of when the user is expected to retrieve certain type of information, such 5 pm news information being viewed at 6 pm, based upon a pattern of desiring such information. Accordingly, the system may select to cache the potentially desirable information prior to the user's selection of that material. Therefore, the habits of the user may be used to select desirable information.

1. A method for modifying a set of informational material for presentation on a video presentation device for a user comprising:
(a) said user selecting a plurality of different informational materials; and
(b) modifying said set of informational materials for said user based upon the duration that said different channels are selected over a temporal time period.

2. The method of claim 1 further comprising selecting each one of said plurality of informational materials with a remote control.

3. The method of claim 1 wherein said informational materials are displayed as a result of selecting a information functionality with a remote control.

4. The method of claim 3 wherein said selecting said informational materials functionality is by pressing a button.

5. The method of claim 1 wherein said temporal time period is a plurality of days.

6. The method of claim 1 wherein one of said plurality of selected different informational materials is free from modifying said set of informational materials if said duration is less than a threshold.

7. The method of claim 6 wherein said threshold is 3 seconds.

8. The method of claim 1 wherein one of said plurality of selected different informational materials is free from modifying said set of informational materials if said duration is greater than a threshold.

9. The method of claim 8 wherein said threshold is 45 seconds.

10. The method of claim 6 wherein one of said plurality of selected different informational materials is free from modifying said set of informational materials if said duration is greater than a threshold.

11. The method of claim 10 wherein said threshold is 45 seconds.

12. The method of claim 1 wherein said set of informational materials is less than all available informational materials.

13. The method of claim 1 wherein said modifying is further based upon the time of day that said different informational materials are selected.

14. The method of claim 1 wherein said modifying is further based upon the day of the week that said different informational materials are selected.

15. The method of claim 1 wherein said modifying is further based upon the day of the month that said different informational materials are selected.

16. The method of claim 1 wherein said set of informational materials is determined in a manner free from explicit user definition.

17. The method of claim 3 wherein said informational materials are displayed as a result of selecting said favorite functionality with said remote control, where said set of informational materials is determined in a manner free from explicit user definition.

18. The method of claim 1 further comprising identifying said user.
